(19) United States
(12) Patent Application Publication
(10) Pub. No.: US 2003/0201706 A1
(43) Pub. Date: Oct. 30, 2003

(54) Tension mask frame assembly and cathode ray tube having the same

(76) Inventors: Kuen-Dong Ha, Seongnam-City (KR); Joon-Seong Park, Suwon-City (KR)

Correspondence Address: Robert E. Bushnell, Suite 300, 1522 K Street, N.W., Washington, DC, 20005, US

(21) Appl. No.: 10/419,948

(22) Filed: Apr. 22, 2003

(30) Foreign Application Priority Data
Apr. 24, 2002 (KR) 22458/2002

(51) Int. Cl. H01J 29/80

(52) U.S. Cl. 313/404

(57) ABSTRACT

A tension mask frame assembly for a color cathode ray tube (CRT) includes a frame and a tension mask installed to apply tension to the support members and where a plurality of electron beam passing holes are formed. The frame includes a pair of first and second support members separated a predetermined distance, first and second elastic members installed between the first and second support members and supporting the first and second support members; and first, second, third, and fourth holder units installed at the first and second support members and the first and second elastic members and respectively including first, second, third, and fourth holders and first, second, third, and fourth springs fixed to the first, second, third, and fourth holders. A thermal expansion coefficient of a material forming the third and fourth holders is no more than that of a material forming the first and second elastic members.

### CLAIM OF PRIORITY

This application makes reference to, incorporates the same herein, and claims all benefits accruing under 35 U.S.C §119 from my application FRAME FOR THE TENSION MASK-FRAME ASSEMBLY AND CATHODE RAY TUBE HAVING THE SAME filed with the Korean Industrial Property Office on Apr. 24, 2002 and there duly assigned Serial No. 22458/2002.

### BACKGROUND OF THE INVENTION

1. Technical Field

The present invention relates to a color cathode ray tube (CRT), and more particularly to a tension mask frame assembly having an improved thermal compensation feature compensating for a mislanding of an electron beam.

2. Related Art

In a color cathode ray tube, three electron beams are emitted from an electron gun and land on fluorescent substances for red, green and blue colors coated on a fluorescent film formed on a screen surface of a panel via passing electron beam passing holes of a mask having a color selection function. The electron beams excite the fluorescent substances to form an image.

In the above color cathode ray tube forming an image, the mask having a color selection function is divided into a dot mask adopted in a computer monitor and a slot mask (or slit mask) used in a television.

A tension mask that is one of the slot masks is supported by a frame to apply tension considering a screen surface which is flat to compensate for distortion of an image and widen a view angle of a screen, and a lot of developments have been performed. A mask frame assembly which support a frame and a mask so that tension is applied by the frame is installed in a panel of a color cathode ray tube.

A color cathode ray tube includes a panel having a screen surface that is flat where a fluorescent film is formed, a tension mask frame assembly suspended on an inner surface of the panel, a funnel coupled to the panel forming a seal, where an electron gun is sealed in a neck portion, and a deflection yoke installed at a cone portion of the funnel.

A tension mask frame assembly includes a tension mask where a plurality of long slots are formed, support members for supporting corresponding edges of the tension mask, and elastic members for applying tension to the tension mask by supporting the respective end portions of the support members.

The tension mask frame assembly having the above structure attempts to compensate for mislanding of electron beams due to thermal expansion as it is heated by the electron beams that do not pass through the slots which are electron beam passing holes.

Exemplars of recent efforts in the art are disclosed, for example, in Japanese Publication Number 08-124489 to Imada et al., entitled COLOR SORTING DEVICE, published on May 17, 1996, Korean Patent Application No. 2001-1878 to Ha et al., entitled MASK-FRAME ASSEMBLY FOR COLOR CATHODE-RAY TUBE, filed on Jan. 12, 2001, U.S. patent application Ser. No.09/938,838 (Publication No. US-2002-0135286-A1) to Ha et al., entitled MASK-FRAME ASSEMBLY FOR COLOR CATHODE-RAY TUBE, published on Sep. 26, 2002, Korean Patent Application No. 2001-65365 entitled MASK FRAME ASSEMBLY AND COLOR CRT USING THE SAME, filed on Oct. 23, 2001, and U.S. patent application Ser. No. 10/269,075 entitled MASK FRAME ASSEMBLY AND COLOR CRT USING THE SAME. A structure of a panel of a tension mask frame assembly is disclosed in the Japanese Publication No. hei 8-124489.

While these contemporary efforts contain merit, it is our observation that further improvements can also be contemplated to more sufficiently compensate for movement due to thermal expansion, to achieve more improvements including better color purity.

### SUMMARY OF THE INVENTION

To solve the above-described problems, the present invention provides a tension mask frame assembly which can improve a thermal compensation feature due to a thermal expansion by the electron beam emitted from the electron gun and whose structure is simple so that a production cost is reduced, and a color cathode ray tube using the same.

The present invention provides a tension mask frame assembly in which the thermal deformation force of the electron beam at low and high temperatures can be easily compensated.

The present invention provides a tension mask frame assembly for a color cathode ray tube comprising a frame which comprises a pair of first and second support members separated a predetermined distance, first and second elastic members installed between the first and second support members and supporting the first and second support members, and first, second, third, and fourth holder units installed at the first and second support members and the first and second elastic members and respectively including first, second, third, and fourth holders and first, second, third, and fourth springs fixed to the first, second, third, and fourth holders, and a tension mask installed to apply tension to the support members and where a plurality of electron beam passing holes are formed, in which a thermal expansion coefficient of a material forming the third and fourth holders is no more than that of a material forming the first and second elastic members.

In the present invention, each of the first through fourth holder units has a structure including a holder fixed to the first and second support members or the first and second elastic members and a spring coupled to the holder and where a through hole into which a stud pin is coupled is formed. A thermal expansion coefficient of a material forming the first and second holder units can be greater than that of a material forming the first and second elastic members.

In accordance with the principles of the present invention, as embodied and broadly described, the present invention provides a tension mask frame assembly for a color cathode ray tube, the assembly comprising: a frame, comprising: first and second support members being separated a predetermined distance; first and second elastic members being installed between said first and second support members, supporting said first and second support members, said elastic members including a first material having a first thermal expansion coefficient; first and second securing units, said first securing unit being installed at said first support member and including a first holder and a first spring fixed to said first holder, said second securing unit being installed at said second support member and including a second holder and a second spring fixed to said second holder; and third and fourth securing units, said third securing unit being installed at said first elastic member and including a third holder and a third spring fixed to said third holder, said fourth securing unit being installed at said second elastic member and including a fourth holder and a fourth spring fixed to said fourth holder, said third and fourth holders including a second material having a second thermal expansion coefficient, with the second thermal expansion coefficient being selected from a coefficient that is less than the first thermal expansion coefficient and a coefficient that is equal to the first thermal expansion coefficient; and a tension mask being installed to apply tension to said support members, said tension mask forming a plurality of electron beam passing holes.

In accordance with the principles of the present invention, as embodied and broadly described, the present invention provides a tension mask apparatus, comprising: first and second support members; an elastic member being installed between said first and second support members, supporting said first and second support members, said elastic member including a first material having a first thermal expansion coefficient; a first securing unit being installed on said elastic member, said first securing unit including a first holder and a first spring fixed to said first holder, said first holder including a second material having a second thermal expansion coefficient, with the second thermal expansion coefficient being selected from a coefficient that is less than the first thermal expansion coefficient and a coefficient that is equal to the first thermal expansion coefficient; and a tension mask being installed to apply tension to said support members, said tension mask forming a plurality of electron beam passing holes.

In accordance with the principles of the present invention, as embodied and broadly described, the present invention provides a tension mask apparatus, comprising: a first member; a second member being connected to said first member, supporting said first member, said second member including a first material having a first thermal expansion coefficient; a first securing unit being installed on said second member, said first securing unit including a first holder and a first spring fixed to said first holder, said first holder including a second material having a second thermal expansion coefficient, with the second thermal expansion coefficient being selected from a coefficient that is less than the first thermal expansion coefficient and a coefficient that is equal to the first thermal expansion coefficient; and a tension mask being installed to apply tension to said first member, said tension mask forming a plurality of electron beam passing holes.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a partially cut-away perspective view of a color cathode ray tube;

FIG. 2 is a perspective view of a mask frame assembly;

FIG. 3 is a partially cut-away, enlarged perspective view of a mask frame assembly;

FIG. 4 is a partially cut-away perspective view of a mask frame assembly;

FIG. 5 is a partially cut-away perspective view of a color cathode ray tube, in accordance with the principles of the present invention;

FIG. 6 is an exploded perspective view of a first embodiment of the mask frame assembly shown in FIG. 5, in accordance with the principles of the present invention;

FIG. 7 is a perspective view illustrating a second embodiment of a mask frame assembly, in accordance with the principles of the present invention; and

FIG. 8 is a partially cut-away perspective view showing the operation of a mask frame assembly, in accordance with the principles of the present invention.

### DESCRIPTION OF BEST MODE OF CARRYING OUT THE INVENTION

While the present invention will be described more fully hereinafter with reference to the accompanying drawings, in which details of the present invention are shown, it is to be understood at the outset of the description which follows that persons of skill in the appropriate arts may modify the invention here described while still achieving the favorable results of this invention. Accordingly, the description of the best mode contemplated of carrying out the invention, which follows, is to be understood as being a broad, teaching disclosure directed to persons of skill in the appropriate arts, and not as limiting upon the present invention.

Illustrative embodiments of the best mode of carrying out the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

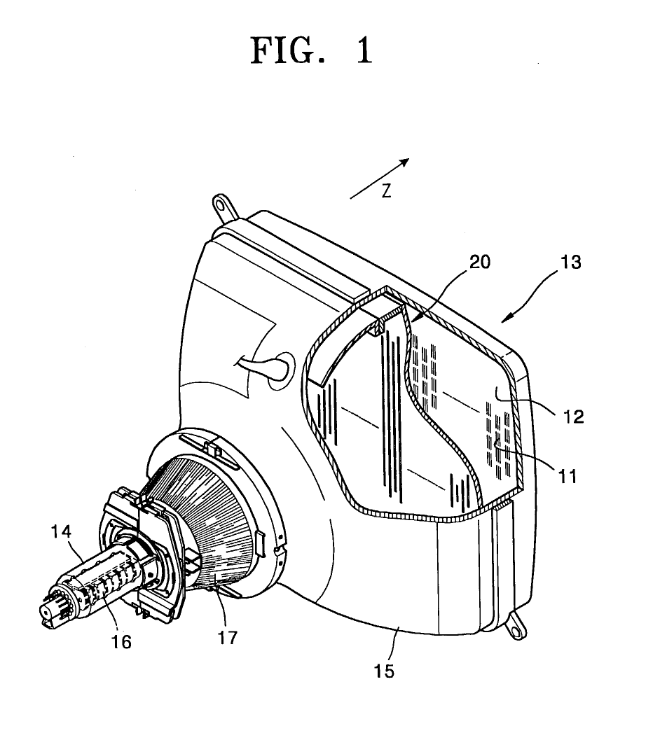

A mask frame assembly which support a frame and a mask so that tension is applied by the frame is installed in a panel of a color cathode ray tube. FIG. 1 shows an example of the color cathode ray tube. FIG. 1 is a partially cut-away perspective view of a color cathode ray tube.

Referring to FIG. 1, a color cathode ray tube includes a panel 13 having a screen surface 12 that is flat where a fluorescent film 11 is formed, a tension mask frame assembly 20 suspended on an inner surface of the panel 13, a funnel 15 coupled to the panel 13 forming a seal, where an electron gun 16 is sealed in a neck portion 14, and a deflection yoke 17 installed at a cone portion of the funnel 15.

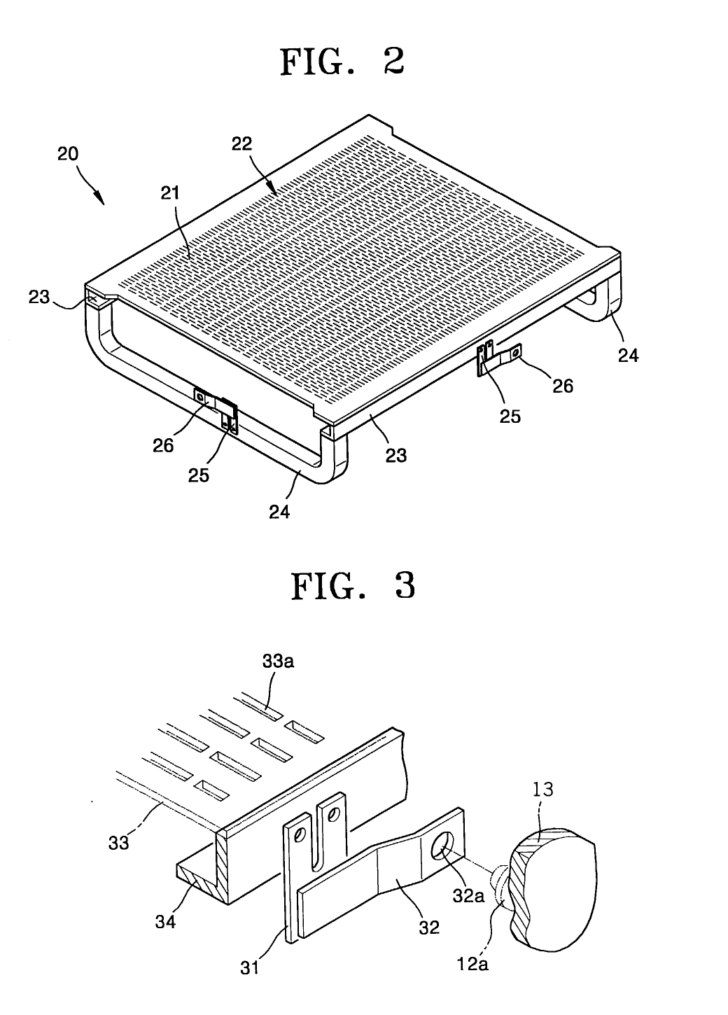

FIG. 2 is a perspective view of a mask frame assembly. The tension mask frame assembly 20, as shown in FIG. 2, includes a tension mask 22 where a plurality of long slots 21 are formed, support members 23 for supporting corresponding edges of the tension mask 22, and elastic members 24 for applying tension to the tension mask 22 by supporting the respective end portions of the support members 23.

The mask frame assembly 20 is suspended inside the panel 13 by a spring supporter 25 and a hook 26 supported by the spring supporter 25 and coupled to a stud pin installed at an inner surface of the panel 13.

The tension mask frame assembly 20 having the above structure compensates for mislanding of electron beams due to thermal expansion as it is heated by the electron beams that do not pass through the slots 21, which are electron beam passing holes, when the spring supporter 25 formed of a bimetal is deformed to move the tension mask assembly 20 toward the panel 13.

FIG. 3 is a partially cut-away, enlarged perspective view of a mask frame assembly. Referring to FIG. 3, a spring supporter 31 formed of a bimetal is fixed at an outer surface of the frame, and a spring 32 where a coupling hole 32a to which a stud pin 12a installed in an inner surface of the panel 13 is coupled is fixed to an end portion of the spring support 31. The spring 32 is formed of a single material.

In the color cathode ray tube including a fixed structure of the above tension mask frame assembly, the fluorescent substance is excited as the electron beams emitted from the electron gun 16 land on the fluorescent film after they are deflected by the deflection yoke 17 and passed through the electron beam passing holes 33a of the tension mask 33. In this process, part of the electron beams emitted from the electron gun passes through the slots that are electron beam passing holes of the tension mask. Approximately 15% of the beams pass through the slots. The electron beam which does not pass through the electron beam passing holes collides against the tension mask to heat it. Thus, the tension mask 33 and the frame 34 supporting the tension mask 33 are heated by the electron beam, that is, thermions, and thermally expanded.

The thermal expansion of the tension mask 33 and the frame 34 entails movement of the electron beam passing holes of the tension mask, causing the electron beams to undesirably misland on the fluorescent film. The heating due to the electron beam causes the spring supporter 31 formed of a bimetal to be thermally deformed and the tension mask frame assembly to move toward the panel. Accordingly, the electron beam passing holes moved due to the thermal deformation of the tension mask 33 are placed on the paths of the electron beams so that the thermal expansion of the tension mask frame assembly is compensated.

However, as the spring supporter 31 thermally expands, the tension mask frame assembly rotates so that excess compensation occurs in the external environment at a low or high temperature. The rotating component of the tension mask frame assembly and the movement of the frame assembly in the cold/hot environment generate mislanding of the electron beam so that the quality of an image is deteriorated. Also, since the spring supporter is formed of a bimetal, a manufacture cost is raised.

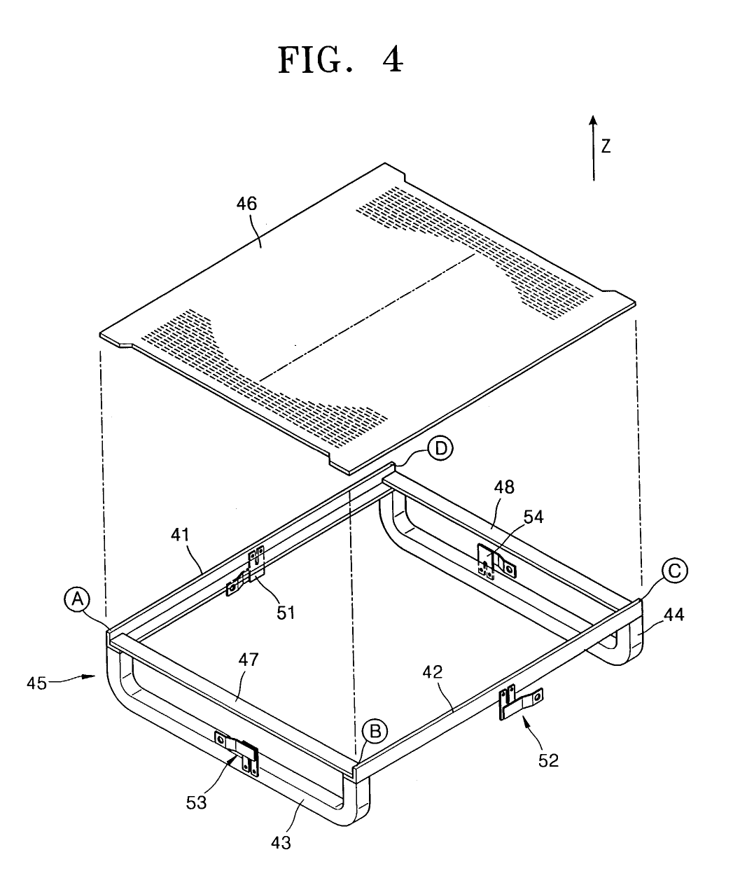

FIG. 4 is a partially cut-away perspective view of a mask frame assembly. Referring to FIG. 4, a tension mask frame assembly includes a frame 45 including a pair of first and second support members 41 and 42 separated a predetermined distance from each other and first and second elastic members 43 and 44 installed between the first and second support members 41 and 42 and supporting the first and second support members 41 and 42 to be separated by a predetermined distance, and a tension mask 46 installed to apply tension to the support members and where a plurality of electron beam passing holes are formed. Also, the tension mask frame assembly includes bars 47 and 48 installed at the first and second support members 41 and 42 to compensate for mislanding of electron beams due to thermal deformation of the tension mask 46 and the frame 45 by changing curvature in a direction along the axis of a cathode ray tube of the first and second support members 41 and 42 and the tension mask 46 by a difference in the amount of thermal expansion of the first and second elastic members 43 and 44 and the first and second support members 41 and 42. First and second hook members 51 and 52 extending downward are installed at the support members 41 and 42, respectively, and third and fourth hook members 53 and 54 extending upward are installed at the first and second elastic members 43 and 44, respectively. The first through fourth hook members 51 through 54 are coupled to stud pins installed on an inner surface of the panel so that the tension mask frame assembly is suspended on the inner surface of the panel.

The tension mask frame assembly having the above structure, during driving, the tension mask 46 and the frame 45 thermally expand so that the mislanding of the electron beam is compensated by a change in the curvature of the tension mask 45 and the first and second support members 41 and 42 due to a difference in the amount of thermal expansion of the bars 47 and 48 and the first and second support members 41 and 42.

However, in the tension mask frame assembly, since the first and second hook members 51 and 52 extend downward so that free ends thereof are respectively disposed under the first and second support members 41 and 42 and since the third and fourth hook members 53 and 54 extend upward so that free ends thereof are respectively disposed above the first and second elastic members 43 and 44, during thermal expansion, the directions along which the first and second hook members 51 and 52 and the third and fourth hook members 53 and 54 thermally expand respectively are opposite. Thus, the first and second support members 41 and 42 move toward the panel (the + direction of the z axis that is the axis direction of a cathode ray tube) and acts to compensate for the mislanding due to the thermal expansion amount. However, the first and second elastic members 43 and 44 act by the third and fourth hook members 53 and 54 in a direction separated from the panel (the − direction of the z axis that is the axis direction of a cathode ray tube) so that the end portions of the first and second support members 41 and 42 are prevented from moving toward the panel. As a result, the amount of movement according to the thermal expansion of the electron beam passing holes at the corner portion of the tension mask supported by the frame is not sufficiently compensated, and color purity is deteriorated.

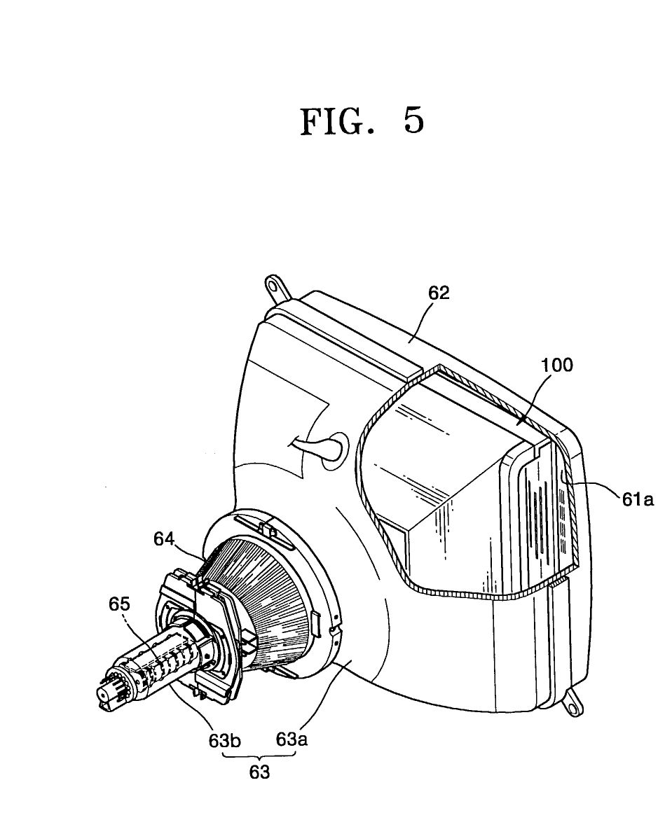

FIG. 5 is a partially cut-away perspective view of a color cathode ray tube, in accordance with the principles of the present invention. As shown in FIG. 5, the cathode ray tube includes a panel 62 having a flat screen where a fluorescent film 61a is formed, a funnel 63 sealed with the panel 62 and having a cone portion 63a and a neck portion 63b, a deflection yoke 64 installed over the cone portion 63a and the neck portion 63b of the funnel 63, and an electron gun 65 sealed in the neck portion 63b. A tension mask frame assembly 100 having a color selection function of an electron beam emitted from the electron gun 65 is installed on an inner surface of the panel 62.

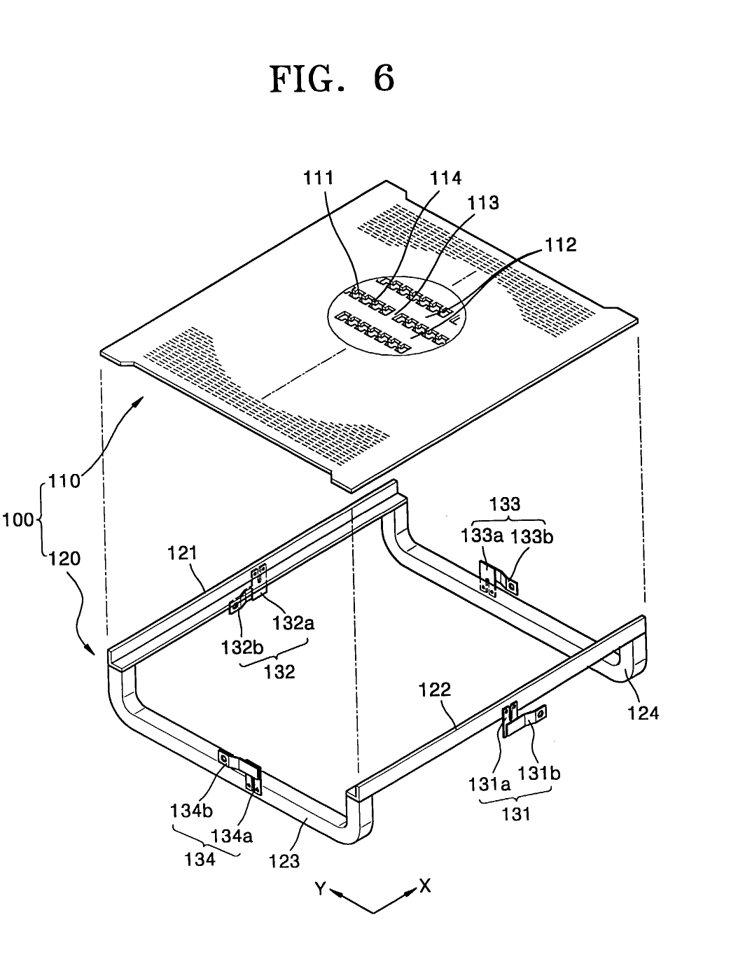

FIG. 6 is an exploded perspective view of a first embodiment of the mask frame assembly shown in FIG. 5, in accordance with the principles of the present invention. The tension mask frame assembly 100, as shown in FIG. 6, includes a tension mask 110 having a plurality of slots extending in a Y direction (a tension direction) and a frame 120 applying tension to the tension mask 110 by supporting long side portions arranged to extend in an X direction that is the longer side of the tension mask 110.

The tension mask 110 includes a plurality of strips 112 separated a predetermined distance and forming slits 111 in a thin plate and a real bridge 113 connecting the strips 112, that are neighboring, to section the slits 111. A dummy bridge 114 with protruding portions extending in the opposite directions from each of the neighboring strips 112 to section the slits 111 may further be formed. The tension mask is not limited to the above-described preferred embodiment and any structure of a tension mask which can apply tension is available.

The frame 120 for supporting both corresponding edges of the tension mask 110 includes a pair of first and second support members 121 and 122 separated a predetermined distance from each other and first and second elastic members 123 and 124 for supporting the first and second support members 121 and 122 so that tension is applied to the tension mask 110 supported by the first and second support members 121 and 122. First and second holder units 131 and 132 are installed at the first and second support members 121 and 122, respectively. The first and second holder units 131 and 132 include first and second holders 131a and 132a extending downward from the first and second support members 121 and 122 and first and second springs 131b and 132b installed at end portions of the first and second holders 131a and 132a, respectively, each having a through-hole coupled to a stud pin (not shown) installed on an inner surface of the panel 62. Third and fourth holder units 133 and 134 include third and fourth holders 133a and 134a installed at the first and second elastic members 123 and 124, respectively, to extend upward therefrom and third and fourth springs 133b and 134b coupled to the stud pins of the panel 62. Installed at end portions of the third and fourth holders 133a and 134a, respectively, are installed at the first and second elastic members 123 and 124, respectively. The holder units 131, 132, 133, and 134 can be referred to as securing units 131, 132, 133, and 134, respectively.

A thermal expansion coefficient of a material forming the third and fourth holder units 133 and 134 is less than or equal to that of a material forming the first and second support members 121 and 122. Preferably, a thermal expansion coefficient of the third and fourth holder units 133 and 134 installed at the first and second elastic members 123 and 124 is less than that of the first and second holder units 131 and 132. Also, a thermal expansion coefficient of the third and fourth holder units 133 and 134 is preferably less than that of the first and second elastic members 123 and 124.

The material of the first and second holder units 131 and 132, that is, the material of the first and second holders 131a and 132a, is SUS 304H (KS standard) and the first and second support members 121 and 122 are formed of SCM 415. The material of the third and fourth holder units 133 and 134, that is, the material of the third and fourth holders 133a and 134a, is preferably INVAR or KOVAR, where INVAR preferably is comprised of 36% through 42% nickel. INVAR is a nickel-iron alloy. KOVAR is a nickel-iron-cobalt alloy. SCM is thermally refined steel. SUS is an austenitic stainless steel.

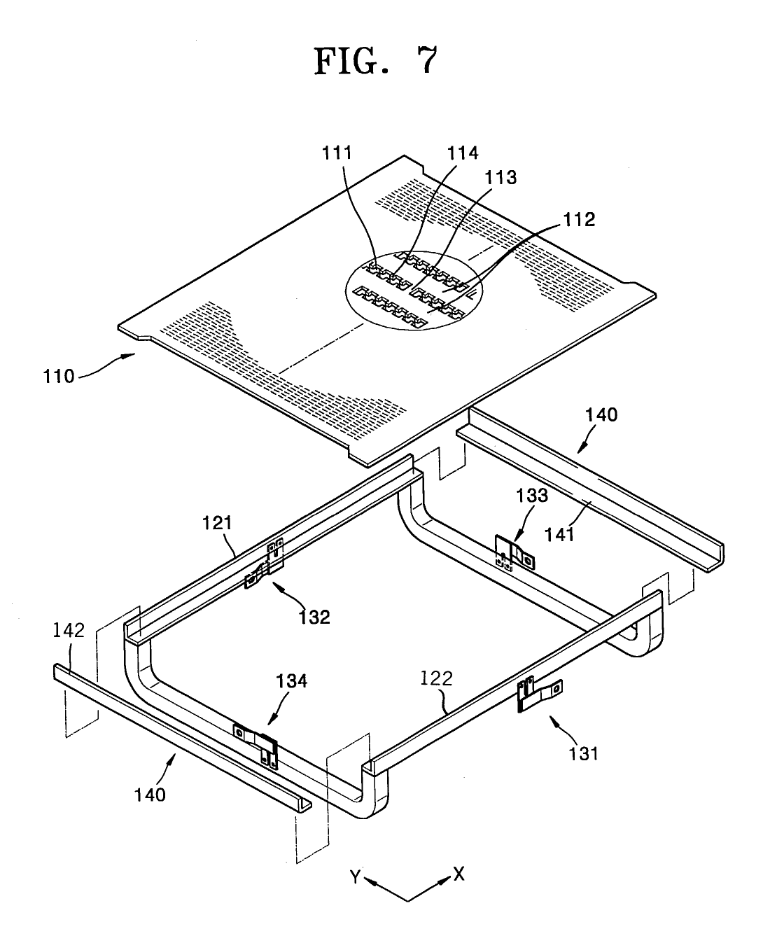

FIG. 7 is a perspective view illustrating a second embodiment of a mask frame assembly, in accordance with the principles of the present invention. Here, the same reference numerals as those in the above preferred embodiment denote the same elements.

Referring to FIG. 7, a compensation unit 140 is installed at end portions of the first and second support members 121 and 122. The compensation unit 140 is for preventing plastic deformation of the mask during a thermal process of the tension mask by correcting the mislanding of the electron beam due to the thermal deformation of the tension mask 110 and the frame 120. The compensation unit 140 is formed of bars 141 and 142 connecting the end portions of the first and second support members 121 and 122. Preferably, an angle bar that is not limited in its profile is used as the bars 141 and 142. The bars 141 and 142 are formed of an INVAR member. In the frame, the first, second, third, and fourth holder units 131 through 134 are installed at the first and second support members 121 and 122 and the first and second elastic members 123 and 124. Since the structure, the material, and the amount of a thermal expansion coefficient according to the material are the same as those described in the above-described preferred embodiment, descriptions hereof will be omitted at this time.

The operation of a color cathode ray tube adopting the tension mask frame assembly having the above structures according to the present invention will now be described below. In the tension mask frame, since the first through fourth holder units 131-134 are coupled to stud pins, when the color cathode ray tube in which the tension mask frame assembly is suspended on the inner surface of the panel 62 is driven, a part of the electron beams emitted from the electron gun 65, that is, a part of the thermions, does not pass through the slots 111 that are the electron beam passing holes of the tension mask 110, and heats the tension mask 110 so that the heated tension mask thermally expands. This thermal expansion amount initially moves the slots of the tension mask 110 so that mislanding of the electron beams are generated.

As the frame 120 thermally expands, the first and second support members 121 and 122 which are the constituent elements of the frame 120 are flattened. Since free ends of the first and second holder units 131 and 132 are disposed under the first and second support members 121 and 122, the amount of thermal expansion of the first and second holder units 131 and 132, that is, the first and second holders 131a and 132a, moves the first and second support members 121 and 122 toward the fluorescent film 61a. Since the third and fourth holders 133a and 134a of the third and fourth holder units 133 and 134 are formed of a material having a thermal expansion coefficient less than that of the first and second holders 131a and 132a, the restriction of both the end portions of the first and second support members 121 and 122, supported by the first and second elastic members 123 and 124, moving toward the fluorescent film is prevented. Thus, the support members 121 and 122 are more freely permitted to move toward the fluorescent film, in accordance with the principles of the present invention.

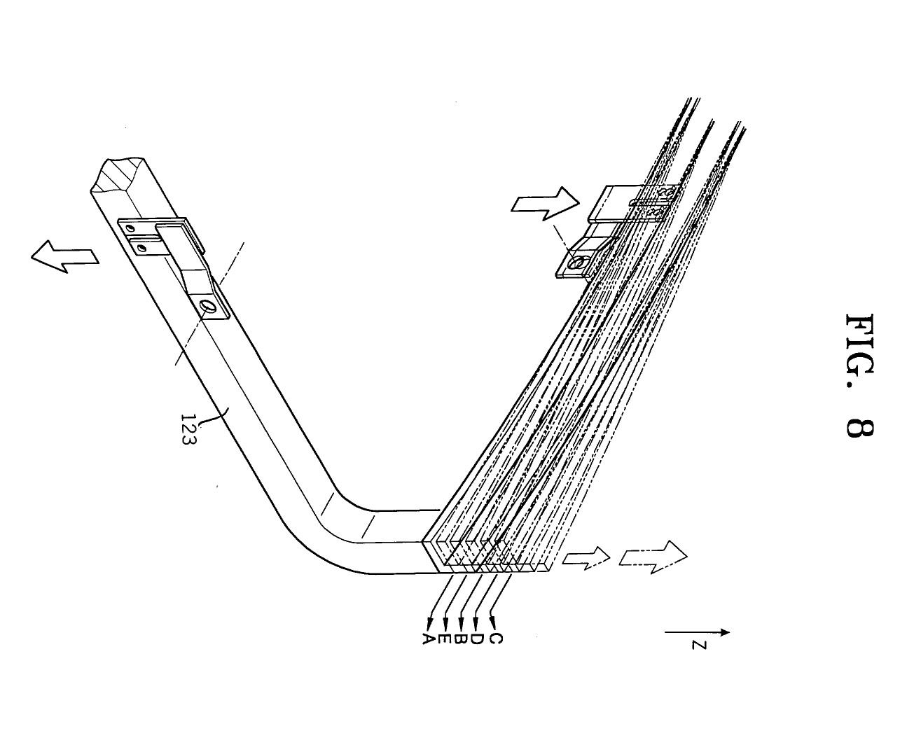

The above operation is described below in detailed with reference to FIG. 8. FIG. 8 is a partially cut-away perspective view showing the operation of a mask frame assembly, in accordance with the principles of the present invention. Referring to FIG. 8, in the state in which the shadow mask frame assembly 110 does not thermally expand (at a position A of FIG. 8), the mask frame assembly thermally expands and thus the first and second support members 121 and 122 are flattened. As the first and second holder units 131 and 132 thermally expand, the first and second support members 121 and 122 are moved in direction Z toward the fluorescent film of the panel (to a position B of FIG. 8). Here, the direction in which the first and second elastic members 123 and 124, move due to the thermal expansion of the third and fourth holder units 133 and 134 installed at the first and second elastic members 123 and 124, is away from the fluorescent film, so that the end portions of the first and second support members 121 and 122 are pulled away from the fluorescent film of the panel. Since the third and fourth holders 133a and 134a of the third and fourth holder units 133 and 134 are formed of a material having a thermal expansion coefficient less than that of the first and second holders 131a and 132a of the first and second holder units 131 and 132, thermal expansion is restricted so that a displacement by pulling in a direction in which the end portions of the first and second support members 121 and 122 are separated away from the panel can be minimized. Thus, a difference in the amount of compensation between a middle portion and a side portion of the first and second support members 121 and 122 can be reduced. Further, the movement of a position slot (to a position E of FIG. 8) due to thermal expansion to a position set at the corner portion of the tension mask 110 supported by the first and second support members 121 and 122 can be compensated so that color purity of an image can be improved.

Meanwhile, in the preferred embodiment in which the bars 141 and 142 are installed at the end portion of the first and second support members 121 and 122, as shown in FIG. 7, the amount of compensation is increased by the flatness of the first and second support members 121 and 122 according to the expansion of the frame. Since the thermal expansion coefficient of the third and fourth holders 133a and 134b of the third and fourth holder units 133 and 134 is small, the final compensation amount (a position D of FIG. 8) according to the thermal expansion of the frame and mask is relatively greater.

The above-described operation will be more apparent by the following experiments.

### Experiment 1

In the present experiment, 32 inch color cathode ray tubes adopting the tension mask frame assembly according to the present invention are tested. SUS 304H is used for the first and second holders 131a and 132a of the first and second hook members 131 and 132 installed at the first and second support members 121 and 122 constituting the tension mask frame assembly and SUS 420J2 is used for the first and second springs 131b and 132b. The holders 133a and 134a of the third and fourth holder units 133 and 134 installed at the first and second elastic members 123 and 124 are tested, and Table 1 is obtained therefrom. The Table 1 shows results of tests when holders 133a and 134a are both composed of INVAR, and when holders 133a and 134a are both composed of SUS.

TABLE 1

| Material for | | | | | | | Average of |
|---|---|---|---|---|---|---|---|
| 3^{rd} and 4^{th} | Peak Value | | Stable Amount | | Delta | | Reference- |
| Holders | Reference | Diagonal | Reference | Diagonal | Reference | Diagonal | Diagonal |
| INVAR | −2 μm | −16.3 μm | 1.5 μm | 19.5 μm | 11.5 μm | 36.3 μm | 13 μm |
| SUS | −6 μm | −15.5 μm | 9 μm | 27.3 μm | 15.5 μm | 42.8 μm | 24 μm |

In Table 1, the “reference” indicates the position of a horizontal end on a central line of a mask and the “diagonal” indicates an average at the four corners of the mask. The term “horizontal end” indicates one of the ends of a central horizontal line which is coplanar with and passes through the center of a mask. As shown in FIG. 6 the central horizontal line (no reference numeral) runs through the center of the tension mask 110. The “peak value” and the “stable amount” indicate the maximum change amount of the beam movement amount within the initial 30 minutes and a change in temperature by the operation until after 3 hours elapse, and of the beam movement amount in the state where the beam movement amount according to the change in temperature is stable. The “delta” indicates a width of the total movement amount until a stable state in a low current state.

As can be seen from Table 1, when the third and fourth holders welded to the short side portions, that is, the first and second elastic members, are formed of INVAR steel, the amount of deviation of landing of the electron beam at the diagonal portion of an image is improved by more than 7 μm in the stable amount, compared to a case in which SUS is used. That is, there is an improvement of more than 7 μm when the 19.5 μm (INVAR) is compared to the 27.3 μm (SUS).

### Experiment 2

In the present experiment, 34 inch color cathode ray tubes adopting the tension mask frame assembly according to the present invention are tested. The material of the first and second holders constituting the tension mask frame assembly are the same as in the above preferred embodiment. The holders 133a and 134a of the third and fourth holder units 133 and 134 installed at the first and second elastic members 123 and 124 are tested, and Table 2 is obtained therefrom. The Table 2 shows a comparison of the results of tests when holders 133a and 134a are both composed of INVAR, are both composed of SUS, and are both composed of bimetal.

TABLE 2

| Material for | | | | | | | Average of |
|---|---|---|---|---|---|---|---|
| 3^{rd} and 4^{th} | Peak Value | | Stable Amount | | Delta | | Reference- |
| Holders | Reference | Diagonal | Reference | Diagonal | Reference | Diagonal | Diagonal |
| INVAR | 18 μm | −16.3 μm | 1.5 μm | 19.5 μm | 11.5 μm | 36.3 μm | 13 μm |
| SUS | 30 μm | −11 μm | 30 μm | 46 μm | μm | 57 μm | 16 μm |
| Bimetal | 18 μm | −14 μm | −11 μm | 10 μm | 11 29 μm | 24 μm | 21 μm |

As can be seen from Table 2, when the third and fourth holders welded to the short side portions, that is, the first and second elastic members, are formed of INVAR steel, the amount of deviation of landing of the electron beam at the corner portion of an image is improved by more than 20 μm, compared to a case in which SUS is used. That is, there is an improvement of more than 20 μm when the 19.5 μm (INVAR) is compared to the 46 μm (SUS). Also, when the third and fourth holders of INVAR steel is used, it can be said that the average of (Reference-Diagonal) is reduced and a landing feature of the electron beam in the areas of low and high temperatures is improved.

As described above, in the tension mask frame assembly of a color cathode ray tube according to the present invention, since a material having a thermal expansion coefficient less than the first and second elastic members is used for the holder units installed at the first and second elastic members, the amount of mislanding of the electron beam at the corner portion of the fluorescent film can be corrected. Furthermore, color purity of an image formed as the fluorescent film is excited by the electron beam can be improved.

The foregoing paragraphs describe the details of the present invention as it relates to a color cathode ray tube (CRT), and more particularly to a tension mask frame assembly having an improved thermal compensation feature to compensate for mislanding of an electron beam due to thermal deformation of a mask to which tension is applied and a frame supporting the mask, and a color cathode ray tube.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit and scope of the applicant's general inventive concept.

What is claimed is:

1. A tension mask frame assembly for a color cathode ray tube, the assembly comprising:
a frame, comprising:
first and second support members being separated a predetermined distance;
first and second elastic members being installed between said first and second support members, supporting said first and second support members, said elastic members including a first material having a first thermal expansion coefficient;
first and second securing units, said first securing unit being installed at said first support member and including a first holder and a first spring fixed to said first holder, said second securing unit being installed at said second support member and including a second holder and a second spring fixed to said second holder; and
third and fourth securing units, said third securing unit being installed at said first elastic member and including a third holder and a third spring fixed to said third holder, said fourth securing unit being installed at said second elastic member and including a fourth holder and a fourth spring fixed to said fourth holder, said third and fourth holders including a second material having a second thermal expansion coefficient, with the second thermal expansion coefficient being selected from a coefficient that is less than the first thermal expansion coefficient and a coefficient that is equal to the first thermal expansion coefficient; and
a tension mask being installed to apply tension to said support members, said tension mask forming a plurality of electron beam passing holes.

2. The assembly of claim 1, with the second material including at least one selected from among INVAR steel, SCM steel, and KOVAR steel.

3. The assembly of claim 2, with the INVAR steel containing 35% through 42% nickel.

4. The assembly of claim 1, with said first and second holders including a third material having a third thermal expansion coefficient, with the second thermal expansion coefficient being less than the third thermal expansion coefficient.

5. The assembly of claim 4, with the second material including at least one selected from among INVAR steel, SCM steel, and KOVAR steel.

6. The assembly of claim 5, with the INVAR steel containing 35% through 42% nickel.

7. The assembly of claim 1, further comprising bars connecting said first and second support members, said bars including a third material having a third thermal expansion coefficient, with the third thermal expansion coefficient being less than the first thermal expansion coefficient.

8. The assembly of claim 1, with said first and second support members and elastic members including SCM steel.

9. A tension mask apparatus, comprising:
first and second support members;
an elastic member being installed between said first and second support members, supporting said first and second support members, said elastic member including a first material having a first thermal expansion coefficient;
a first securing unit being installed on said elastic member, said first securing unit including a first holder and a first spring fixed to said first holder, said first holder including a second material having a second thermal expansion coefficient, with the second thermal expansion coefficient being selected from a coefficient that is less than the first thermal expansion coefficient and a coefficient that is equal to the first thermal expansion coefficient; and
a tension mask being installed to apply tension to said support members, said tension mask forming a plurality of electron beam passing holes.

10. The apparatus of claim 9, with the second material including at least one selected from among INVAR steel, SCM steel, and KOVAR steel.

11. The apparatus of claim 10, with the INVAR steel containing 35% through 42% nickel.

12. The apparatus of claim 9, further comprising a second securing unit being installed on one support member selected from among said first and second support members, said second securing unit including a second holder and a second spring fixed to said second holder, with said second holder including a third material having a third thermal expansion coefficient, with the second thermal expansion coefficient being less than the third thermal expansion coefficient.

13. The apparatus of claim 12, with the second material including at least one selected from among INVAR steel, SCM steel, and KOVAR steel.

14. The apparatus of claim 13, with the INVAR steel containing 35% through 42% nickel.

15. The apparatus of claim 9, further comprising bars connecting said first and second support members, said bars including a third material having a third thermal expansion coefficient, with the third thermal expansion coefficient being less than the first thermal expansion coefficient.

16. The apparatus of claim 9, with said first and second support members and elastic member including SCM steel.

17. A tension mask apparatus, comprising:
a first member;
a second member being connected to said first member, supporting said first member, said second member including a first material having a first thermal expansion coefficient;
a first securing unit being installed on said second member, said first securing unit including a first holder and a first spring fixed to said first holder, said first holder including a second material having a second thermal expansion coefficient, with the second thermal expansion coefficient being selected from a coefficient that is less than the first thermal expansion coefficient and a coefficient that is equal to the first thermal expansion coefficient; and
a tension mask being installed to apply tension to said first member, said tension mask forming a plurality of electron beam passing holes.

18. The apparatus of claim 17, further comprising a second securing unit being installed on said first member, said second securing unit including a second holder and a second spring fixed to said second holder, with said second holder including a third material having a third thermal expansion coefficient, with the second thermal expansion coefficient being less than the third thermal expansion coefficient.

19. The apparatus of claim 18, with the second material including at least one selected from among INVAR steel, SCM steel, and KOVAR steel, with the INVAR steel containing 35% through 42% nickel, and with said first and second members including SCM steel.

20. The apparatus of claim 19, further comprising at least one bar being connected to said first member, said bar including a fourth material having a fourth thermal expansion coefficient, with the fourth thermal expansion coefficient being less than the first thermal expansion coefficient.
